(19) United States
(12) Patent Application Publication
(10) Pub. No.: US 2015/0380695 A1
(43) Pub. Date: Dec. 31, 2015

(54) POLYURETHANE ADHESIVE FOR BATTERY PACKAGING MATERIAL, BATTERY PACKAGING MATERIAL, BATTERY CONTAINER, AND BATTERY

(71) Applicants: TOYO INK SC HOLDINGS CO., LTD., Chuo-ku, Tokyo (JP); TOYO-MORTON, LTD., Chuo-ku, Tokyo (JP); TOYOCHEM CO., LTD., Chuo-ku, Tokyo (JP)

(72) Inventors: Hiroshi HANAKI, Tokyo (JP); Satoshi MAEDA, Tokyo (JP); Takeshi YOSHIKAWA, Tokyo (JP)

(73) Assignee: TOYO INK SC HOLDINGS CO., LTD., Tokyo (JP)

(21) Appl. No.: 14/768,873

(22) PCT Filed: Feb. 20, 2014
(86) PCT No.: PCT/JP2014/000881

§ 371 Date: Aug. 19, 2015

(30) Foreign Application Priority Data
Feb. 25, 2013 (JP) 2013-034957
Dec. 11, 2013 (JP) 2013-255982

(51) Int. Cl. H01M 2/08; C09J 175/06; H01M 2/02

(52) U.S. Cl. CPC H01M 2/08; H01M 2/0287; H01M 2/0285; H01M 2/0277; H01M 2/0207; C09J 175/06; H01M 2220/30

(57) ABSTRACT

An adhesive with which a battery packaging material capable of maintaining a strong adhesive strength even after a long-term endurance test and having an excellent moldability can be formed is provided. A polyurethane adhesive for a battery packaging material according to the present invention includes a main agent and a curing agent, in which the main agent contains an acrylic polyol (A) having a number-average molecular weight of 10,000 to 100,000 and a hydroxyl value of 1 to 100 mgKOH/g, and an equivalent ratio [NCO]/[OH] of an isocyanate group derived from an aromatic polyisocyanate (B) contained in the curing agent to a hydroxyl group derived from the acrylic polyol (A) is 10 to 30.

### TECHNICAL FIELD

The present invention relates to a polyurethane adhesive for a battery packaging material for forming a battery container or a battery pack. Further, the present invention also relates to a battery packaging material laminated by using the aforementioned polyurethane adhesive for a battery packaging material. Further, the present invention also relates to a battery container that is molded from the aforementioned battery packaging material and a battery formed by using the battery container.

### BACKGROUND ART

Because of the rapid growth of electronic device fields such as mobile phones and portable computers, the demand for secondary batteries such as light and small lithium-ion batteries has increased. As packages for secondary batteries, metal cans have been used in the past. However, packaging materials formed by laminating plastic films and/or aluminum foils have been entering the mainstream in view of their lightness and productivity.

Examples of the simplest packaging materials include a laminate shown in FIG. 1, which includes, from the outer side thereof, an outer layer side resin film layer (11), an outer layer side adhesive layer (12), a metal foil layer (13), an inner layer side adhesive layer (14), and an inner surface layer (15) composed of a heat seal layer or the like. As a battery container, there is one shown in FIG. 2, for example, which is molded from the above-described packaging material (i.e., performing deep-draw molding, stretch-expand forming, or the like) so that the outer layer side resin film layer (11) forms a convex surface and the inner surface layer (15) forms a concave surface. A battery is produced by encapsulating electrodes, an electrolytic solution, and the like on the concave surface side of the battery container and sealing the battery container.

As a battery packaging material, Patent Literature 1 discloses a battery packaging material in which a heat-resistant resin drawn film layer disposed on an outer layer side, a thermoplastic resin un-drawn film layer disposed on an inner layer side, and an aluminum foil layer disposed therebetween are laminated, and in which the thermoplastic resin un-drawn film layer is bonded with the aluminum foil layer with an adhesive layer containing a polyolefin resin containing a carboxyl group and a polyfunctional isocyanate compound interposed therebetween.

Further, Patent Literature 2 discloses a packaging material for an electronic component case including, from an outer side thereof, a heat-resistant resin drawn film layer, an aluminum foil layer, and a thermoplastic resin un-drawn film layer as essential components, in which an acrylic polymer layer is provided between the aluminum foil layer and the thermoplastic resin un-drawn film layer.

Further, it is mentioned in Patent Literature 3 that in a lithium battery packaging material, as an adhesive used between a base material layer such as a drawn polyamide film and an aluminum foil layer, an isocyanate compound is used as a curing agent in the main agent such as polyester polyol and acrylic polyol. Further, it is mentioned that a ratio NCO/OH is preferably 1 to 10, and more preferably 2 to 5. Further, Patent Literatures 4 to 6 disclose battery packaging materials.

### CITATION LIST

### Patent Literature

### Patent Literature 1: Japanese Unexamined Patent Application Publication No. 2010-92703

### Patent Literature 2: Japanese Unexamined Patent Application Publication No. 2002-187233

Patent Literature 3: Japanese Unexamined Patent Application Publication No. 2012-124067, paragraph [0025]

### Patent Literature 4: Japanese Unexamined Patent Application Publication No. 2002-002511

Patent Literature 5: International Patent Publication No. WO2008/093778
Patent Literature 6: International Patent Publication No. WO2009/041077

### SUMMARY OF INVENTION

### Technical Problem

In recent years, as the range of use of electricity storage devices has expanded so that they are now being used in vehicles, for the storage of electricity in individual houses, and so on, it has been desired to increase the capacities of secondary batteries. As a result, it has been desired that battery packaging materials have excellent moldability.

Further, since vehicle-mounted secondary batteries and secondary batteries used for storing electricity in individual houses are installed outdoors and it is thus desired that they have long life expectancies, it has been desired that the adhesive strength of the battery packaging materials be maintained even after a long-term endurance test and no abnormality occur in their external appearances.

The present invention has been made in view of the above-described background and an object thereof is to provide a battery, a battery container, a battery packaging material, and a polyurethane adhesive for a battery packaging material having excellent moldability, a high inter-layer adhesive strength even after a long-term endurance test, and an excellent external appearance.

### Solution to Problem

The present invention has been made in view of the above-described object and relates to a polyurethane adhesive for a battery packaging material including a main agent and a curing agent, in which the main agent contains an acrylic polyol (A) having a number-average molecular weight of 10,000 to 100,000 and a hydroxyl value of 1 to 100 mgKOH/g, and an equivalent ratio [NCO]/[OH] of an isocyanate group derived from an aromatic polyisocyanate (B) contained in the curing agent to a hydroxyl group derived from the acrylic polyol (A) is 10 to 30.

In the polyurethane adhesive for a battery packaging material according to the present invention, a glass transition temperature (Tg) of the acrylic polyol (A) is preferably −20 to 30° C.

Further, the polyurethane adhesive for a battery packaging material according to the present invention preferably further includes a silane coupling agent (C) and at least one type of an additive selected from a group consisting of a phosphoric acid and a phosphoric-acid-based compound (D).

Further, the present invention relates to a battery packaging material including, from an outer side thereof, an outer layer side resin film layer, an outer layer side adhesive layer, a metal foil layer, an inner layer side adhesive layer, and an inner surface layer as essential components, in which the outer layer side adhesive layer is formed by the above-described polyurethane adhesive for a battery packaging material according to the present invention.

In the battery packaging material according to the present invention, the outer layer side resin film layer is preferably a polyamide film or/and a polyester film, and the inner surface layer is preferably a polyolefin-based film.

Further, the present invention relates to a battery container that is molded from the above-described battery packaging material, in which the outer layer side resin film layer forms a convex surface and the inner surface layer forms a concave surface.

Further, the present invention relates to a battery that is formed by using the above-described battery container.

### Advantageous Effects of Invention

The present invention provides an excellent advantageous effect that it is possible to provide a battery, a battery container, a battery packaging material, and a polyurethane adhesive for a battery packaging material having excellent moldability, a high inter-layer adhesive strength even after a long-term endurance test, and an excellent external appearance.

### BRIEF DESCRIPTION OF DRAWINGS

FIG. 1 is a schematic cross section showing an aspect of a battery packaging material according to the present invention; and

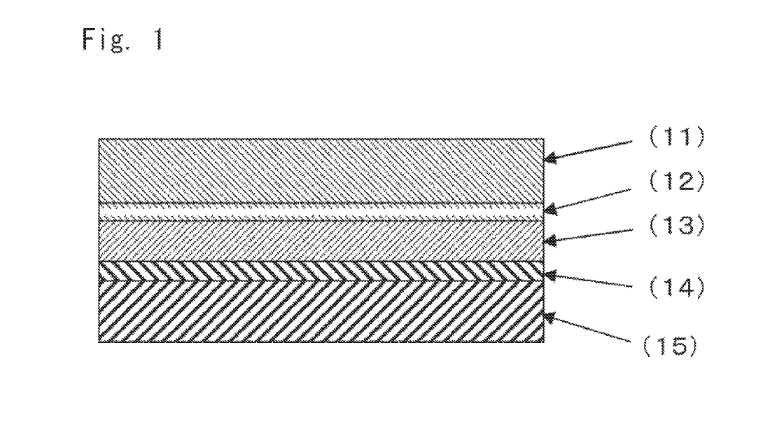

FIG. 2 is a schematic perspective view of an aspect (tray-type) of a battery container according to the present invention.

### DESCRIPTION OF EMBODIMENTS

Exemplary embodiments according to the present invention are explained hereinafter in detail. Note that in this specification, the expression “an arbitrary number A to an arbitrary number B” means a range including a number A, numbers greater than the number A and smaller than a number B, and the number B.

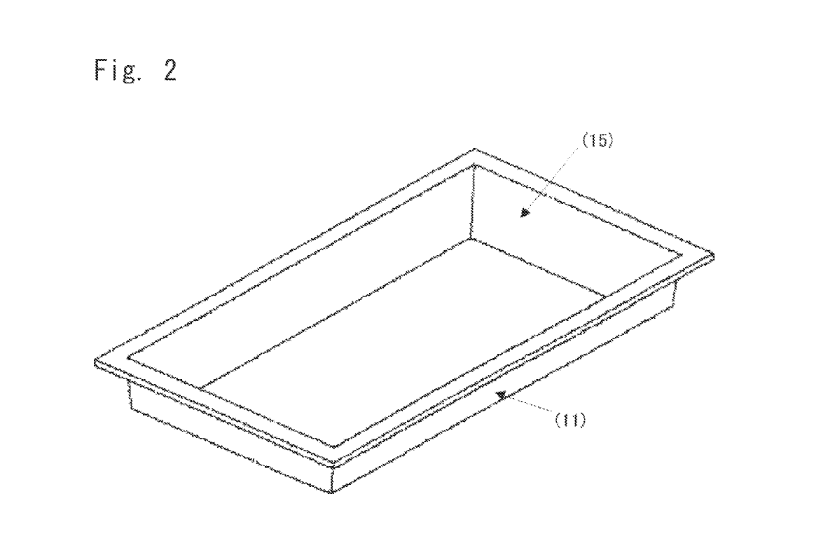

A polyurethane adhesive according to the present invention is used to form a battery packaging material that is used to obtain a battery container. There is no particular restriction on the shape of the battery container. Examples of the shapes include a cylindrical shape (a cylinder, a rectangular cylinder, an elliptic cylinder, and so on) as well as the tray-like shape shown in FIG. 2. Such battery containers are obtained by molding them from flat battery packaging materials. The inner side of a battery container, i.e., the surface that is brought into contact with an electrolytic solution, is referred to as an inner surface layer (15). Preferable examples of the inner surface layer (15) include a heat seal layer. By using a heat seal layer, it is possible to fuse (i.e., fusion-bond) an inner surface layer (15) in a flange section another inner surface layer (15) of another battery packaging material or with another inner surface layer (15) in a flange section of another battery container by facing these inner surface layers (15) toward each other, bringing them into contact with each other, and heating them. By doing so, an electrolytic solution can be hermitically encapsulated in the battery packaging materials. A preferable example of the inner surface layer is a polyolefin-based film, though it is not limited to any particular material as long as it is within the spirit and scope of the present invention.

The battery container includes a metal foil (13). In general, a battery container is divided into two sections on its metal foil (13), and the section closer to the electrolytic solution is referred to as “inner side” and the section further from the electrolytic solution is referred to as “outer side”. Further, a layer located on the inner side is referred to as “inner layer” and a layer located on the outer side is referred to as “outer layer”. Therefore, a battery packaging material that is going to be used for forming a battery container is also divided into two sections on its metal foil (13), and the section closer to the electrolytic solution is referred to as “inner side” and the section further from the electrolytic solution is referred to as “outer side”. Further, a layer located on the inner side is referred to as “inner layer” and a layer located on the outer side is referred to as “outer layer”.

A polyurethane adhesive according to the present invention is suitable for a purpose of laminating (bonding) an outer layer side resin film layer (11) and a metal foil layer (13) on each other.

A polyurethane adhesive according to the present invention uses a main agent and a curing agent. The polyurethane adhesive may be the so-called “two-liquids mixing type adhesive” in which the curing agent is mixed with the main agent when the adhesive is used, or a “one-liquid type adhesive” in which the curing agent is mixed with the main agent in advance. Further, the polyurethane adhesive may be a type in which a plurality of main agents and/or a plurality of curing agents are mixed when the adhesive is used.

In the polyurethane adhesive according to the present invention, the main agent is a polyol component containing a hydroxyl group and contains an acrylic polyol (A). The polyol component may further include a polyol(s) other than the acrylic polyol (A) in a range in which the purposes/effects of the present invention are attained.

As the acrylic polyol (A), a copolymer of a mono(meth)acrylate monomer containing a hydroxyl group and a mono(meth)acrylate monomer containing no hydroxyl group is preferably used. The mono(meth)acrylate monomer containing a hydroxyl group is a monomer containing one (meth)acryloyl group and at least one hydroxyl group in one molecule. Examples of the mono(meth)acrylate monomer containing a hydroxyl group include a mono(meth)acrylic ester monomer of monohydric alcohol or dihydric alcohol.

A mono(meth)acrylic ester monomer containing one hydroxyl group can be obtained by, for example, reacting dihydric alcohol with (meth)acrylic acid. Examples of the mono(meth)acrylate monomer containing include 2-hydroxyethyl (meth)acrylate, 2-hydroxypropyl (meth)acrylate, 3-hydroxypropyl (meth)acrylate, 2-hydroxybutyl (meth)acrylate, 4-hydroxybutyl acrylate (brand name “4HBA” manufactured by Mitsubishi Chemical Corporation), 4-hydroxybutyl methacrylate, α-hydroxymethyl ethyl acrylate, α-hydroxymethyl acrylate, caprolactone-modified hydroxy(meth)acrylate (brand name “Placcel F-Series” manufactured by Daicel Chemical Industries, Ltd.), and (poly)ethylene glycol mono(meth)acrylate.

Further, a mono(meth)acrylic ester monomer containing two hydroxyl groups such as (meth)acrylic acid 2,3-dihydroxypropyl can also be used. It can be obtained by, for example, reacting trihydric alcohol with (meth)acrylic acid.

Examples of the mono(meth)acrylate monomer include monomers containing a cycloalkyl group such as cyclohexyl(meth)acrylate, methyl cyclohexyl(meth)acrylate, tert-butyl cyclohexyl(meth)acrylate, and cyclododecyl(meth)acrylate, methyl acrylate, ethyl acrylate, n-butyl acrylate, isobutyl acrylate, tert-butyl acrylate, sec-butyl acrylate, n-propyl acrylate, isopropyl acrylate, isoamyl acrylate, 2-ethyl hexyl acrylate, isodecyl acrylate, tridecyl acrylate, n-octyl acrylate, isooctyl acrylate, n-lauryl acrylate, benzyl acrylate, dicyclopentanyl acrylate, n-stearyl acrylate, isostearyl acrylate, isobornyl acrylate, 2-(acetoacetoxy)ethyl acrylate, phenoxy ethyl acrylate, methyl methacrylate, ethyl methacrylate, n-butyl methacrylate, isobutyl methacrylate, tert-butyl methacrylate, sec-butyl methacrylate, n-propyl methacrylate, isopropyl methacrylate, isoamyl methacrylate, 2-ethyl hexyl methacrylate, isodecyl methacrylate, tridecyl methacrylate, n-octyl methacrylate, isooctyl methacrylate, n-lauryl methacrylate, benzyl methacrylate, dicyclopentanyl methacrylate, n-stearyl methacrylate, isostearyl methacrylate, isobornyl methacrylate, 2-acetoacetoxy ethyl methacrylate (brand name “AAEM”, EASTMAN), and phenoxy ethyl methacrylate. Further, monomers containing a carboxyl group such as (meth)acrylic acid, maleic acid, and maleic anhydride, or their anhydrides can be used. Alternatively, vinyl monomers such as styrene can be used.

Regarding the molecular weight of the acrylic polyol (A), its number-average molecular weight is preferably 10,000 to 100,000, and more preferably 20,000 to 70,000.

When battery packaging materials are manufactured in an industrial manner, a long laminate is wound into a roll. Then, to sufficiently cure adhesive layers in the rolled laminate, the rolled laminate is subjected to aging for several days in a storehouse maintained at a high temperature.

By adjusting the number-average molecular weight of the acrylic polyol (A) to 10,000 or higher, it is possible to improve the cohesive force of the adhesive layers prior to the aging or during the curing process and thereby reduce/prevent the occurrences of abnormalities in the manufacturing such as defective external appearances (occurrences of misalignment and separation in the rolled state). Further, by adjusting the number-average molecular weight of the acrylic polyol (A) to 10,000 or higher, it is possible to reduce/prevent the embrittlement of the cured coatings and thereby ensure that the peel stress between the base material and the adhesive is eased, thus making it possible to reduce/prevent the deterioration of the lamination strength and the occurrence of separation caused by the insufficient adhesive force.

On the other hand, by adjusting the number-average molecular weight of the acrylic polyol (A) to 100,000 or lower, it is possible to ensure the solubility into a diluted solvent, thus making it possible to adjust the viscosity in the adhesive coating process within an appropriate range and thereby secure the coating property. Note that it is presumed that: the dried coating at the early curing stage after the application of the adhesive has a high structural viscosity due to the entanglement of acryl molecular chains; the flexibility of hydroxyl groups in the side chains is lowered; and hence the reaction between hydroxyl groups in the acrylic polyol (A) and isocyanate groups in the later-described curing agent is hindered. By adjusting the number-average molecular weight of the acrylic polyol (A) to 100,000 or lower, it is possible to suppress the entanglement of acryl molecular chains at the early curing stage, secure a sufficient level of urethane cross-linking by reducing the hindrance to the reaction between hydroxyl groups and isocyanate groups, and thereby provide a packaging material having excellent moldability.

The number-average molecular weight of the acrylic polyol (A) is a value in terms of polystyrene obtained by gel permeation chromatography (GPC). For example, it is a value that is obtained by measurement in which: the temperature of columns (KF-805L, KF-803L, and KF-802 manufactured by Showa Denko K.K.) is adjusted to 40° C.; THF is used as an eluent; the flow rate is adjusted to 0.2 mL/min; RI detection is used; the sample concentration is adjusted to 0.02%; and polystyrene is used as a reference sample. Number-average molecular weights in the present invention are values measured by the above-described method.

The hydroxyl value of the acrylic polyol (A) is 1 to 100 mgKOH/g, preferably 1 to 50 mgKOH/g, and more preferably 1 to 15 mgKOH/g. If the hydroxyl value is higher than 100 mgKOH/g, the density of the cross-linking between the acrylic polyol (A) and the aromatic isocyanate (B) contained as the curing agent becomes so high that the adhesive force with the outer layer side resin film layer deteriorates, thus deteriorating the moldability.

By adjusting the hydroxyl value of the acrylic polyol (A) within the above-described range, an excellent adhesive strength is achieved between the outer layer side resin film layer and the metal foil layer. Further, since the acrylic polyol (A) and the aromatic polyisocyanate (B) contained in the curing agent form cross-linking at an appropriate density, excellent moldability can be achieved.

Further, the glass transition temperature of the acrylic polyol (A) is preferably in a range of −20 to 30° C., and more preferably in a range of 0 to 15° C.

By adjusting the glass transition temperature of the acrylic polyol (A) within the above-described range, a molded article having excellent moldability and an excellent moisture/heat resistance while having a sufficient initial tackiness for keeping the adhesive strength immediately after the laminating process can be obtained.

The glass transition temperature of the acrylic polyol (A) is measured by DSC measurement. Specifically, the glass transition temperature is obtained based on a DSC chart that is obtained by cooling a sample of about 10 mg to −100° C. and then raising the temperature of the sample at 10° C./min. When the acrylic polyol (A) is dissolved in an organic solvent, its glass transition temperature is obtained by drying it and then performing a process similar to the above-described process.

Regarding the polyol component contained in the main agent, a polyol(s) other than the acrylic polyol (A) can be used together with the acrylic polyol (A). Examples of the polyol other than the acrylic polyol (A) include low-molecular polyols such as ethylene glycol and trimethylol propane, polyether polyol, polycarbonate polyol, polyolefin polyol, and polyester polyol. Further, examples also include polyurethane polyol obtained by reacting one or more than one of these substances with organic isocyanate. The polyol other than the acrylic polyol (A) can be used in a range in which the polyol has no harmful effect on the adhesive strength and the moldability.

The polyurethane adhesive according to the present invention includes aromatic polyisocyanate (B) as a curing agent. The aromatic polyisocyanate (B) may be in a state where the polyisocyanate is diluted by an organic solvent or in a state where the polyisocyanate is not diluted.

Examples of the aromatic polyisocyanate (B) include:

aromatic diisocyanates such as m-phenylene diisocyanate, p-phenylene diisocyanate, 4,4′-diphenyl diisocyanate, 1,5-naphthalene diisocyanate, 4,4′-diphenylmethane diisocyanate, 2,4- or 2,6-tolylene diisocyanate, or mixtures thereof, 4,4′-toluidine diisocyanate, dianisidine diisocyanate, 4,4′-diphenylether diisocyanate;

polyisocyanate monomers such as organic triisocyanates such as triphenylmethan-4,4′,4″-triisocyanate, 1,3,5-triisocyanate benzene, and 2,4,6-triisocyanate toluene, and organic tetraisocyanates such as 4,4′-diphenyl dimethylmethane-2,2′-5,5′-tetraisocyanate;

dimers, trimers, biurets, and allophanates derived from the aforementioned polyisocyanate monomers, polyisocyanates including a 2,4,6-oxadiazinetrion ring obtained from a carbonic acid gas and the aforementioned polyisocyanate monomer;

adducts in which a low-molecular polyol having a molecular weight lower than 200 such as ethylene glycol, propylene glycol, butylene glycol, hexylene glycol, neopentyl glycol, 1,6-hexanediol, 3-methyl-1,5-pentanediol, 3,3′-dimethylol propane, cyclohexane dimethanol, diethylene glycol, triethylene glycol, dipropylene glycol, glycerol, trimethylol propane, pentaerythritol, and sorbitol are added to the aforementioned polyisocyanate monomer; and

adducts in which substances having a molecular weight 200 to 20,000 such as polyester polyol, polyether ester polyol, polyester amide polyol, polycaprolactone polyol, polyvalerolactone polyol, acrylic polyol, polycarbonate polyol, polyhydroxy alkane, an ricinus oil, and polyurethane polyol are added to the above-described polyisocyanate monomers.

Among them, organic polyisocyanates derived from 4,4′-diphenylmethane diisocyanate, 2,4- or 2,6-tolylene diisocyanate are preferred in view of the productivity and the moldability of packaging materials.

In the polyurethane adhesive according to the present invention, the equivalent ratio [NCO]/[OH] of isocyanate groups derived from the aromatic polyisocyanate (B) contained in the curing agent to hydroxyl groups derived from the acrylic polyol (A) contained in the main agent is 10 to 30 and preferably 15 to 25. By adjusting the amount of aromatic isocyanate groups to 10 moles or larger with respect to one mole of hydroxyl groups, an adhesive layer having a sufficient cross-linking density can be formed, thus making it possible to obtain a packaging material (i.e. packaging laminate) having excellent moldability. On the other hand, by adjusting the amount of aromatic isocyanate groups to 30 moles or smaller with respect to one mole of hydroxyl groups, it is possible to obtain a packaging material having an excellent lamination strength without requiring a long time for the completion of the curing process. Further, adjusting the amount of aromatic isocyanate groups to 30 moles or smaller is also desirable in view of hygiene and cost.

It is considered that by adjusting the above equivalent ratio within the above-described range, it is possible to form a coating, which requires a high Young's modulus, having both strong adhesiveness to the metal foil layer and moldability owing to the self-cross-linking by the urea bonding between aromatic isocyanate groups, and owing to the formation of terminal amine structures by the reaction between part of the aromatic isocyanate and moisture.

The polyurethane adhesive according to the present invention preferably includes a silane coupling agent (C) in order to improve the adhesive strength to a metallic raw material such as a metal foil.

Examples of the silane coupling agent (C) include: trialkoxy silanes containing a vinyl group such as vinyl trimethoxy silane, and vinyl triethoxy silane; trialkoxy silanes containing an amino group such as 3-aminopropyl triethoxy silane, and N-(2-aminoethyl) 3-amino propyl trimethoxy silane; and trialkoxy silanes containing a glycidyl group such as 3-glycidoxy propyl trimethoxy silane, 2-(3,4-epoxycyclohexyl) ethyl trimethoxy silane, and 3-glycidoxy propyl triethoxy silane. Each of these substances can be solely used, or two or more of these substances can be arbitrarily combined with each other and used in combination.

The amount of the silane coupling agent (C) is preferably 0.1 to 5 pts·mass and more preferably 0.5 to 3 pts·mass with respect to 100 pts·mass of the solid content of the polyol component. By adding an amount of the silane coupling agent (C) within the above-described range, the adhesive strength to the metal foil can be improved. Further, the silane coupling agent (C) is preferably contained in the main agent together with the acrylic polyol (A).

The polyurethane adhesive used in the present invention preferably includes a phosphoric acid or a phosphate compound (D) in order to improve the adhesive strength to a metallic raw material such as a metal foil. Further, the phosphoric acid or the phosphate compound (D) is preferably contained in the main agent together with the acrylic polyol (A).

Of the phosphoric acid and the phosphate compound (D), the phosphoric acid may be any phosphoric acid containing at least one free oxygen acid. Examples of the phosphoric acid include phosphoric acids such as hypophosphorous acid, phosphorous acid, orthophosphoric acid, and hypophosphoric acid, and condensed phosphoric acids such metaphosphoric acid, pyrophosphoric acid, tripolyphosphoric acid, polyphosphoric acid, and ultraphosphoric acid. Further, examples of the phosphoric-acid-based compound, which is a derivative of a phosphoric acid, include those that are obtained by partially converting the above-described phosphoric acid into an ester with alcohols in a state where at least one free oxygen acid remains. Examples of these alcohols include aliphatic alcohols such as methanol, ethanol, ethylene glycol, and glycerin, and aromatic alcohols such as phenol, xylenol, hydroquinone, catechol, and phloroglucinol. Only one type of the phosphoric acid or the phosphate compound (D) may be used, or two or more of these substances can be arbitrarily combined with each other and used in combination. The amount of the phosphoric acid or the phosphate compound (D) is preferably 0.01 to 10 mass %, more preferably 0.05 to 5 mass %, and particularly preferably 0.05 to 1 mass % based on the solid content of the adhesive.

Further, a publicly-known additive for an adhesive can be mixed with the main agent or the curing agent. For example, a reaction accelerating agent can be used. Examples include: metallic catalysts such as dibutyltin diacetate, dibutyltin dilaurate, dioctyltin dilaurate, and dibutyltin dimalate; tertiary amines such as 1,8-diazabicyclo(5,4,0)undecene-7,1,5-diazabicyclo(4,3,0)nonene-5,6-dibutyl amino-1, and 8-diazabicyclo(5,4,0)undecene-7; and reactive tertiary amines such as triethanolamine. One or more than one reaction accelerating agent selected from these substances can be used.

A publicly-known leveling agent or an antifoaming agent can be mixed with the main agent in order to improve the external appearance of the laminate. Examples of the leveling agent includes polyether-modified polydimethyl siloxane, polyester-modified polydimethyl siloxane, aralkyl-modified polymethyl alkylsiloxane, polydimethyl siloxane containing a polyester-modified hydroxyl group, polydimethyl siloxane containing a polyether-ester-modified hydroxyl group, an acrylic copolymer, a methacrylic copolymer, polyether-modified polymethyl alkylsiloxane, an alkyl acrylate ester copolymer, an alkyl methacrylate ester copolymer, and lecithin.

Examples of the antifoaming agent include publicly-known antifoaming agents such as a silicone resin, a silicone solution, and a copolymer of alkyl vinyl ether, alkyl acrylate ester, and alkyl methacrylate ester.

A battery packaging material according to the present invention can be manufactured by, for example, a commonly-used method.

For example, an outer layer side resin film layer (11) and a metal foil layer (13) may be laminated on each other by using a polyurethane adhesive according to the present invention and an intermediate laminate is thereby obtained. Next, an inner surface layer (15) may be laminated on the metal foil layer (13) surface of the intermediate laminate by using an inner layer side adhesive.

Alternatively, a metal foil layer (13) and an inner surface layer (15) may be laminated on each other by using an inner layer side adhesive and an intermediate laminate is thereby obtained. Next, the metal foil layer (13) of the intermediate laminate and an outer layer side resin film layer (11) may be laminated on each other by using a polyurethane adhesive according to the present invention.

In the former case, the polyurethane adhesive according to the present invention may be applied on one surface of one of the base materials, i.e., one of the outer layer side resin film layer (11) and the metal foil layer (13). After the solvent is evaporated and dissipated, the other base material is placed over the adhesive layer in a heated and pressured state. Next, the adhesive layer may be cured by performing aging at a normal temperature or a high temperature. The amount of the adhesive layer is preferably about 1 to 15 g/m².

In the latter case, similarly to the former case, the polyurethane adhesive according to the present invention may be applied to either the outer layer side resin film layer (11) or the metal foil layer (13) surface of the intermediate laminate.

A solvent may be contained in a polyurethane-based adhesive in order to adjust the viscosity of the coating liquid to an appropriate value when the polyurethane-based adhesive is applied to a base material as long as the solvent have no harmful effect on the base material in the drying process.

Examples of the solvent include: ketone compounds such as acetone, methyl ethyl ketone, methyl isobutyl ketone, and cyclohexanone; ester compounds such as methyl acetate, ethyl acetate, butyl acetate, ethyl lactate, and methoxyethyl acetate; ether compounds such as diethyl ether and ethylene glycol dimethyl ether; aromatic compounds such as toluene and xylene; aliphatic compounds such as pentane and hexane; halogenated hydrocarbon compounds such as methylene chloride, chlorobenzene, and chloroform; alcohols such as ethanol, isopropyl alcohol, and normal butanol; and water. Only one of these solvents may be used, or two or more of them may be used together.

Examples of the device for applying the polyurethane-based adhesive in the present invention include a comma coater, a dry laminator, a roll knife coater, a die coater, a roll coater, a bar coater, a gravure roll coater, a reverse roll coater, a blade coater, a gravure coater, and a micro-gravure roller coater.

There is no particular restriction on the outer layer side resin film layer (11) included in the battery packaging material according to the present invention. However, the use of a drawn film made of polyamide or polyester is preferred. Further, the outer layer side resin film layer (11) may be colored by using pigments such as carbon black and titanium oxide. Further, the outer layer side resin film layer (11) may be coated with a coating agent for giving a slip property, preventing scratches, or/and giving a corrosion resistance against a hydrogen fluoride, or/and coated with an ink for giving a design. Further, two or more layers of films may be laminated in advance. There is no particular restriction on the thickness of the film layer. However, the thickness is preferably 12 to 100 μm.

There is no particular restriction on the thickness of the metal foil layer (13) included in the battery packaging material according to the present invention. However, the thickness of the metal foil layer (13) is preferably 20 to 80 μm. Further, the metal foil layer surface is preferably subjected to a chemical treatment by using phosphate, chromate, fluoride, a triazine thiol compound, an isocyanate compound, or the like. By performing the chemical treatment, the corrosion/deterioration of the metal foil layer surface caused by the electrolytic solution of the battery can be prevented or reduced. Further, it is preferable to perform an organic treatment by baking a publicly-known metal processing agent such as an amide resin, an acrylic resin, and a coupling agent at a high temperature of about 200° C. onto the metal on the chemically-treated surface. By performing the organic treatment, the meal foil layer and the adhesive can be strongly bonded, thus preventing or reducing the occurrences of separation between the metal foil layer and the adhesive even further.

There is no particular restriction on the inner surface layer (15) included in the battery packaging material according to the present invention. However, the inner surface layer (15) is preferably a heat seal layer, and preferably an un-drawn film made of at least one type of a thermoplastic resin selected from a group consisting of polyethylene, polypropylene, olefin copolymers, acid-modified substances thereof, and ionomers thereof. There is no particular restriction on the thickness of the film. However, the thickness is preferably 20 to 150 μm.

There is no particular restriction on the adhesive for forming the inner layer side adhesive layer (14) included in the battery packaging material according to the present invention. However, those whose adhesive strength between the metal foil layer (13) and the inner surface layer (15) is not lowered due to the electrolytic solution of the battery are preferred. Further, publicly-known adhesives can be used.

For example, the metal foil layer (13) and the inner surface layer (15) can be bonded to each other by applying an adhesive obtained by combining a polyolefin resin and polyfunctional isocyanate or an adhesive obtained by combining polyol and polyfunctional isocyanate on the metal foil layer by using a gravure coater or the like, drying the solvent, placing the inner surface layer (15) over the adhesive layer in a heated and pressured state, and then performing aging at a normal temperature or a high temperature.

Alternatively, the metal foil layer (13) and the inner surface layer (15) can be bonded to each other by melting and extruding an adhesive such as an acid-modified polypropylene onto the metal foil layer (13) by using a T-die extruder, and placing the inner surface layer (15) over the adhesive layer.

When both of the outer layer side adhesive layer (12) and the inner layer side adhesive layer (14) need to be subjected to aging, they can be subjected to the aging together. Note that by adjusting the aging temperature to a temperature between a room temperature and 90° C., the adhesive layer(s) is cured in 2 days to 2 weeks and moldability is developed.

A battery container according to the present invention can be obtained by molding it from the above-described battery packaging material in such a manner that the outer layer side resin film layer (11) forms a convex surface and the inner surface layer (15) forms a concave surface.

Note that in the present invention, the term “concave surface” means a surface with a recess formed therein where an electrolytic solution can be contained when a tray-like electricity storage device container shown in FIG. 2 is molded from a flat battery packaging material. Further, the term “convex surface” in the present invention means a surface opposed to the aforementioned surface with the recess formed therein.

In the battery packaging material in accordance with the present invention, since a polyurethane adhesive according to the present invention is used to form an outer layer side adhesive layer, it is possible to achieve an excellent inter-layer adhesive strength, effectively prevent the rupture of a film in the molding process, and effectively prevent the occurrences of separation in the molded parts. Further, it is possible to provide a battery packaging material capable of maintaining the above-described properties even after an endurance test is carried out. Further, it is possible to provide a reliable battery by using a battery container obtained by using the aforementioned battery packaging material.

### EXAMPLES

Next, the present invention is further explained in a specific manner by using examples and comparative examples. The symbol “%” in the examples and the comparative examples all means “mass %”.

### Synthesis Example of Acrylic Polyol

Firstly, 100 pts·mass of ethyl acetate was put in a four-neck flask equipped with a condenser, a nitrogen feeding tube, a dropping funnel, and a thermometer, and the content was heated to 80° C. Then, a monomer solution, which was obtained in advance by mixing 41.5 pts·mass of n-butyl acrylate, 56.5 pts·mass ethyl methacrylate, 1.0 pts·mass of an acrylic acid, 1.0 pts·mass of 2-hydroxyethyl acrylate, and 0.4 pts·mass of azobisisobutyl nitrile, was dropped in the four-neck flask over a period of two hours by using the dropping funnel. After that, the reaction was continued for one hour and 0.04 pts·mass of azobisisobutyl nitrile was added. Further, after the reaction was continued for another one hour, the content was cooled and an ethyl acetate was added. As a result, an acrylic polyol solution (A−1) having a solid content of 50% was obtained.

Acrylic polyol solutions (A-2) to (A-12) each having a solid content of 50% were obtained in a manner similar to that for the acrylic polyol solution (A-1) except that monomer compositions shown in Table 1 were used, i.e., except that the molecule weights were adjusted by changing the amount of the polymerization initiator, i.e., azobisisobutyl nitrile, and the monomer compositions were changed.

Note that the number-average molecular weights and the glass transition temperatures were obtained by GPC and DSC as described above.

Specifically, the number-average molecular weights were obtained as follows: the temperature of columns (KF-805L, KF-803L, and KF-802 manufactured by Showa Denko K.K.) was adjusted to 40° C.; THF was used as an eluent; the flow rate was adjusted to 0.2 mL/min; RI detection was used; the sample concentration was adjusted to 0.02%; and polystyrene was used as a reference sample.

Further, the glass transition temperature was obtained based on a DSC chart that was obtained by using a DSC “RDC220” manufactured by Seiko Instruments Inc., weighing about 10 mg of a sample and putting it in an aluminum pan, setting the aluminum pan in the DSC device and cooling it to −100° C. by using liquid nitrogen, and then heating the sample at a rate of 10° C./min.

Further, the acid values and the hydroxyl values were obtained as follows.

### <Measurement of Acid Value (AV)>

About 1 g of the sample (polyester polyol solution) was precisely weighed and put into a stoppered conical flask and 100 mL of a toluene/ethanol mixture solution (volume ratio: toluene/ethanol=2/1) was added, and the sample was dissolved in the mixture solution. A phenolphthalein reagent was added in the solution as an indicator, and the solution was left undisturbed for 30 seconds. After that, the solution was titrated with a 0.1 N alcoholic potassium hydroxide solution until the solution exhibited a salmon-pink color. The acid value was calculated by the following expression (unit: mg KOH/g).

Acid value (mg KOH/g)=(5.611×p×F)/S

where:

S: amount of collected sample (g);

p: amount of consumed 0.1 N alcoholic potassium hydroxide solution (mL); and

F: titer of 0.1 N alcoholic potassium hydroxide solution.

### <Measurement of Hydroxyl Value (OHV)>

About 1 g of the sample (polyol solution) was precisely weighed and put into a stoppered conical flask and 100 mL of a toluene/ethanol mixture solution (volume ratio: toluene/ethanol=2/1) was added, and the sample was dissolved in the mixture solution. Exactly 5 mL of an acetylating agent (solution obtained by dissolving 25 g of acetic anhydride into such an amount of pyridine that the total volume became 100 mL) was added to the solution, and the mixture was stirred for about one hour. A phenolphthalein reagent was added in the solution as an indicator, and the solution was left as it was for 30 seconds. After that, the solution was titrated with a 0.1 N alcoholic potassium hydroxide solution until the solution exhibited a salmon-pink color. The hydroxyl value was calculated by the following expression (unit: mg KOH/g).

Hydroxyl value (mg KOH/g)={(q−p)×F×28.25}/S

where:

S: amount of collected sample (g);

p: amount of consumed 0.1 N alcoholic potassium hydroxide solution (mL);

q: amount of 0.1 N alcoholic potassium hydroxide solution consumed in a blank test (mL);

F: titer of 0.1 N alcoholic potassium hydroxide solution; and

D: acid value (mg KOH/g).

### [Production of Main Agent]

Only the acrylic polyols (A−1)-(A-7) and (A-10)-(A-12) were used for the main agents in Examples 1-7, 9, 12 and 13, and Comparative examples 1 to 5. In Example 8, a silane coupling agent (KBM-403) and a phosphoric acid were added for the main agent. Further, in Examples 10 and 11, a silane coupling agent was added for the main agent.

### (Production of Curing Agent (B))

Curing agent B1: A resin solution having a solid content of 70% obtained by diluting a trimethylolpropane modified product of 4,4′-diphenylmethane diisocyanate (TMP adduct modified product) by ethyl acetate was used as “curing agent B1”. The NCO % of the curing agent B1 was 10.0%.

Curing agent B2: A resin solution having a solid content of 52.5% obtained by diluting a trimethylolpropane modified product of tolylene diisocyanate (TMP adduct modified product) by ethyl acetate was used as “curing agent B2”. The NCO % of the curing agent B2 was 9.0%.

Curing agent B3: A resin solution having a solid content of 75% obtained by diluting a trimethylolpropane modified product of hexamethylene diisocyanate (TMP adduct modified product) by ethyl acetate was used as “curing agent B3”. The NCO % of the curing agent B3 was 12.5%.

### Examples 1-13, Comparative Examples 1-5

Polyurethane adhesives were obtained by mixing the main agents and the curing agents in the ratios shown in Table 2 and then adding ethyl acetate so that their nonvolatile contents became 30%.

The equivalent ratio [NCO]/[OH] of the isocyanate group contained in the curing agent to the sum total of the hydroxyl value and the acid vale contained in the main agent was calculated as follows.

[NCO]/[OH]=[561×(NCO % of curing agent)×(amount of mixed curing agent (g) based on 100 g of main agent)/[total hydroxyl value of main agent (mgKOH/g))×42×100]

### Comparative Example 6

A polyurethane adhesive was obtained by mixing AD-502 (manufactured by Toyo-Morton, Ltd., polyester polyol), which was used as the main agent, and CAT-10 (manufactured by Toyo-Morton, Ltd., isocyanate curing agent), which was used as the curing agent, in a ratio (g) shown in Table 2, and then adding ethyl acetate so that its nonvolatile content became 30%.

### Comparative Example 7

Firstly, 83.2 g of isophthalic acid, 83.2 g of terephthalic acid, and 142.6 g of ethylene glycol were put into a vessel, and an esterification reaction was carried out at 200 to 220° C. for eight hours. After a predetermined amount of water is distilled, 188 g of azelaic acid was added and an esterification reaction was carried out another four hours. After a predetermined amount of water is distilled, 0.13 g of tetraisobutyl titanate was added and a transesterification reaction was carried out at 1.3 to 2.7 hPa and at 230 to 250° C. for three hours while gradually reducing the pressure. As a result, polyester polyol having a number-average molecular weight of 22,000 and a Tg of −5° C.

A polyester polyol solution (X) having a hydroxyl value of 2.45 mgKOH/g and an acid value of 0.1 mgKOH/g was obtained by adjusting this polyester polyol by using ethyl acetate so that its nonvolatile content became 50%.

A polyurethane adhesive was obtained by mixing this polyester polyol solution (X) and a curing agent (B) at a ratio (g) shown in Table 2 and then adding ethyl acetate so that its nonvolatile content became 30%.

The above-described polyurethane adhesive was applied as an outer layer adhesive on one of the surfaces of an aluminum foil having a thickness of 40 μm by using a dry laminator so that its coating amount became 5 g/m². After the solvent was evaporated and dissipated, a drawn polyamide film having a thickness of 30 μm was laminated on the outer layer adhesive coating.

Next, the below-described inner layer adhesive was applied on the other surface of the aluminum foil of the obtained laminated film by using a dry laminator so that its coating amount became 5 g/m². After the solvent was evaporated and dissipated, an un-drawn polypropylene film having a thickness of 30 μm was laminated on the inner layer adhesive coating. After that, a curing process (aging) was performed at 60° C. for seven days and the outer layer and inner layer adhesives were cured, and a battery packaging material was thereby obtained.

### (Inner Layer Adhesive)

An inner layer adhesive was obtained by mixing a main agent with a curing agent at a weight ratio “main agent/curing agent=100/10” and adding toluene so that its nonvolatile content became 30%. The main agent was obtained by putting 60 pts·mass of maleic-acid-modified polypropylene (a modified polypropylene resin obtained by graft-polymerizing maleic anhydride with a copolymer of propylene and ethylene, melting point: 67° C., acid value: 13 mgKOH/g) and 40 pts·mass of a completely hydrogenated C9 resin (softening point: 140° C., no acid value), which was used as a tackifier, in a vessel, diluting the mixture by a mixed solvent of “toluene/methyl ethyl ketone=8/2”, and stirring the diluted mixture at 50° C. for three hours. The curing agent was a solution having a solid content of 50% obtained by diluting a trimer of hexamethylene diisocyanate by toluene.

The properties of the battery packaging materials obtained in the above-described manner were evaluated in accordance with the below-described evaluation methods.

### <Lamination Strength Before/after Moisture/Heat Resistance Test>

A battery packaging material was cut into “200 mm×15 mm” pieces. Then, T-type peel tests were carried out by using a tensile tester with a load speed of 300 mm/minute under an environment of a temperature of 20° C. and a relative humidity of 65%. The peel strength (N/15 mm width) between the drawn polyamide film and the aluminum foil was shown by using an average value of five test pieces (lamination strength before moisture/heat resistance test).

Separately, battery packaging materials were put in a temperature/humidity-controlled bath filled with an atmosphere having a temperature of 85° C. and a relative humidity of 85% and left undisturbed for 168 hours. Then, the battery packaging materials were taken out from the temperature/humidity-controlled bath and their lamination strengths were measured in a manner similar to the measurement carried out before the test (lamination strength after moisture/heat resistance test). These materials were categorized into the below-shown four levels according to their average peel strength values:

aa: 6N/15 mm or larger (excellent in practical use);
a: no smaller than 4N/15 mm and smaller than 6N/15 mm (practical range);
b: no smaller than 2N/15 mm and smaller than 4N/15 mm (practical lower limit); and

c: smaller than 2N/15 mm.

Table 3 also shows the above-described results.

### <Moldability Evaluation Method>

A battery packaging material was cut into “80 mm×80 mm” pieces and they were used as blanks (molding materials, raw materials). The blanks were subjected to protruding one-step molding by using a molding-height adjustable straight die in such a manner that the drawn polyamide film was positioned on the outer side. Moldability was evaluated based on the maximum height at which no rupture occurred in the aluminum foil and no separation occurred between each pair of layers.

Note that the punch shape of the used die was a square 30 mm on each side having a corner R of 2 mm and a punch shoulder R of 1 mm. The dice hole shape of the used die was a square 34 mm on each side having a dice hole corner R of 2 mm and a dice hole shoulder R of 1 mm. Further, the clearance on each side between the punch and the dice hole was 0.3 mm. Due to the clearance, an inclination occurred according to the molding height. The battery packaging materials were categorized into the below-shown four levels according to their molding height:

aa: 6 mm or higher (excellent in practical use);

a: no lower than 4 mm and lower than 6 mm (practical range);

b: no lower than 2 mm and lower than 4 mm (practical lower limit); and

c: lower than 2 mm.

Table 3 shows the above-described results.

### <Moisture/Heat Resistance of Molded Article>

A battery packaging material was cut into “60 mm×60 mm” pieces and they were used as blanks (molding materials, raw materials). The blanks were subjected to protruding one-step molding by using a molding-height adjustable straight die whose molding height was adjusted to 3 mm in such a manner that the drawn polyamide film was positioned on the outer side of the battery packaging material. The obtained 30-mm square tray was put in a temperature/humidity-controlled bath filled with an atmosphere having a temperature of 85° C. and a relative humidity of 85% and left undisturbed for 168 hours. The tray was taken out from the temperature/humidity-controlled bath. Then, it was evaluated whether or not any separation occurred between the drawn polyamide film and the aluminum foil by observing the external appearance on or near the boundary between the flange part and the side wall part.

Note that the punch shape of the used die was a square 30 mm on each side having a corner R of 2 mm, a punch shoulder R of 1 mm, and a dice shoulder R of 1 mm.

a: no separation; and

c: separation occurred.

Table 3 also shows the above-described results.

TABLE 1

| Acrylic | Monomer composition | | | | | | Number-average | | Hydroxyl value |
|---|---|---|---|---|---|---|---|---|---|
| polyol (A) | n-BA | EMA | MMA | AA | HEA | 4HBA | molecular weight | Tg (° C.) | (mgKOH/g) |
| A-1 | 41.5 | 56.5 | 0 | 1.0 | 1.0 | 0 | 10000 | 8 | 5.3 |
| A-2 | 41.5 | 56.5 | 0 | 1.0 | 1.0 | 0 | 40000 | 8 | 5.3 |
| A-3 | 41.5 | 56.5 | 0 | 1.0 | 1.0 | 0 | 70000 | 8 | 5.3 |
| A-4 | 42.2 | 56.5 | 0 | 1.0 | 0.3 | 0 | 40000 | 8 | 1.8 |
| A-5 | 36.0 | 53.0 | 0 | 1.0 | 10.0 | 0 | 40000 | 8 | 53 |
| A-6 | 58.0 | 40.0 | 0 | 1.0 | 1.0 | 0 | 40000 | −10 | 5.3 |
| A-7 | 31.0 | 67.0 | 0 | 1.0 | 1.0 | 0 | 40000 | 20 | 5.3 |
| A-8 | 52.0 | 0 | 45.9 | 1.0 | 1.1 | 0 | 40000 | 5 | 5.3 |
| A-9 | 51.7 | 0 | 47.0 | 0 | 0 | 1.4 | 40000 | 5 | 5.3 |
| A-10 | 41.5 | 56.5 | 0 | 1.0 | 1.0 | 0 | 6000 | 8 | 5.3 |
| A-11 | 41.5 | 56.5 | 0 | 1.0 | 1.0 | 0 | 150000 | 8 | 5.3 |
| A-12 | 29.0 | 50.0 | 0 | 1.0 | 20.0 | 0 | 40000 | 8 | 106 |

n-BA: n-butyl acrylate,
EMA: ethyl methacrylate,
MMA: methyl methacrylate,
AA: acrylic acid,
HEA: 2-hydroxyethyl acrylate,
4HBA: 4-hydroxybutyl acrylate

TABLE 2

| | | | | | | | Polyisocynate | | |
|---|---|---|---|---|---|---|---|---|---|
| | Polyole | | | | | | | | Mixing ratio |
| | Acrylic | | Hydroxyl | | Silane | | | | Main agent/ |
| | polyol | Number-average | value | Tg | coupling | Phosphoric | | NCO/OH | Curing agent |
| | (A) | molecular weight | (mgKOH/g) | (° C.) | agent *1 | acid *1 | Type | ratio | (Solution ratio) |
| Example 1 | A-1 | 10000 | 5.3 | 8 | — | — | Curing agent B1 | 15.0 | 100/30 |
| Example 2 | A-2 | 40000 | 5.3 | 8 | — | — | Curing agent B1 | 15.0 | 100/30 |
| Example 3 | A-3 | 70000 | 5.3 | 8 | — | — | Curing agent B1 | 15.0 | 100/30 |
| Example 4 | A-4 | 40000 | 1.8 | 8 | — | — | Curing agent B1 | 15.0 | 100/12 |
| Example 5 | A-5 | 40000 | 53 | 8 | — | — | Curing agent B1 | 15.0 | 100/300 |
| Example 6 | A-6 | 40000 | 5.3 | −10 | — | — | Curing agent B1 | 15.0 | 100/30 |
| Example 7 | A-7 | 40000 | 5.3 | 20 | — | — | Curing agent B1 | 15.0 | 100/30 |
| Example 8 | A-1 | 40000 | 5.3 | 8 | KBM-403 | Contained | Curing agent B1 | 15.0 | 100/30 |
| Example 9 | A-1 | 40000 | 5.3 | 8 | — | — | Curing agent B2 | 15.0 | 100/33 |
| Example 10 | A-8 | 40000 | 5.3 | 5 | KBM-403 | — | Curing agent B2 | 15.0 | 100/33 |
| Example 11 | A-9 | 40000 | 5.3 | 5 | KBM-403 | — | Curing agent B2 | 15.0 | 100/33 |
| Example 12 | A-1 | 40000 | 5.3 | 8 | — | — | Curing agent B1 | 11.0 | 100/20 |
| Example 13 | A-1 | 40000 | 5.3 | 8 | — | — | Curing agent B1 | 25.0 | 100/50 |
| Comparative example 1 | A-1 | 40000 | 5.3 | 8 | — | — | Curing agent B3 | 15.0 | 100/24 |
| Comparative example 2 | A-1 | 40000 | 5.3 | 8 | — | — | Curing agent B1 | 7.0 | 100/15 |
| Comparative example 3 | A-10 | 6000 | 5.3 | 8 | — | — | Curing agent B1 | 15.0 | 100/30 |
| Comparative example 4 | A-11 | 150000 | 5.3 | 8 | — | — | Curing agent B1 | 15.0 | 100/30 |
| Comparative example 5 | A-12 | 40000 | 106.0 | 8 | — | — | Curing agent B1 | 15.0 | 100/600 |

| | | | | |
|---|---|---|---|---|
| Comparative example 6 | AD-502 (manufactured by Toyo-Morton, Ltd., polyester polyol) | CAT-10 | — | 100/7 |
| Comparative example 7 | polyester polyol (D) *2 | Curing agent B2 | 15.0 | 100/20 |

*1 0.5 pts. mass of silane coupling agent and 0.1 pts.mass of phosphoric acid are mixed based on 100 pts.mass of acrylic polyol (A) solution.
*2 Number-average molecular weight 22,000, resin solution hydroxyl value 2.45 mgKOH/g, resin solution acid value 0.1 mgKOH/g, glass transition temperature of resin −5° C.

TABLE 3

| | | | Lamination strength | | | |
|---|---|---|---|---|---|---|
| | | | before/after moisture/ | | | Moisture/heat- |
| | | | heat-resistance test | | | resistance test for |
| Item | Main agent | Curing agent | Before test | After test | Moldability | molded article |
| Example 1 | A-1 | Curing agent B1 | b | a | a | a |
| Example 2 | A-2 | Curing agent B1 | a | aa | aa | aa |
| Example 3 | A-3 | Curing agent B1 | aa | aa | a | b |
| Example 4 | A-4 | Curing agent B1 | a | b | a | b |
| Example 5 | A-5 | Curing agent B1 | b | a | a | b |
| Example 6 | A-6 | Curing agent B1 | a | a | b | b |
| Example 7 | A-7 | Curing agent B1 | b | b | aa | aa |
| Example 8 | A-1 | Curing agent B1 | aa | aa | aa | aa |
| Example 9 | A-1 | Curing agent B2 | a | a | a | a |
| Example 10 | A-8 | Curing agent B2 | aa | aa | aa | aa |
| Example 11 | A-9 | Curing agent B2 | aa | aa | aa | aa |
| Example 12 | A-1 | Curing agent B1 | a | b | b | b |
| Example 13 | A-1 | Curing agent B1 | b | b | aa | aa |
| Comparative example 1 | A-1 | Curing agent B3 | a | b | c | c |
| Comparative example 2 | A-1 | Curing agent B1 | a | b | c | c |
| Comparative example 3 | A-8 | Curing agent B1 | c | c | a | a |
| Comparative example 4 | A-9 | Curing agent B1 | aa | aa | b | c |
| Comparative example 5 | A-10 | Curing agent B1 | c | c | b | b |
| Comparative example 6 | AD-502 | CAT-10 | a | b | a | c |
| Comparative example 7 | polyester polyol | Curing agent B2 | aa | b | c | c |
| | (D) | | | | | |

As understood from Table 3, by using a polyurethane adhesive for battery packaging material that contains an acrylic polyol (A) having a number-average molecular weight of 10,000 to 100,000 and a hydroxyl value of 1 to 100 mgKOH/g and is obtained by mixing an aromatic polyisocyanate (B) contained in a curing agent with the acrylic polyol (A) so that the equivalent ratio [NCO]/[OH] of the isocyanate group derived from the aromatic polyisocyanate (B) to the hydroxyl group derived from the acrylic polyol (A) becomes 10 to 3, It is possible to provide a battery packaging material having an excellent lamination strength before/after a moisture/heat resistance test, excellent moldability, a high inter-layer adhesive strength even in a long-term endurance test, and an excellent external appearance. Further, it can be understood that a molded article having an excellent moisture/heat resistance can be formed from a battery packaging material using a polyurethane adhesive for a battery packaging material.

Comparative example 1 was as good as the examples according to the present invention in its lamination strength before the moisture/heat resistance test. However, since aliphatic polyisocyanate was used as the polyisocyanate of the curing agent, the lamination strength after the moisture/heat resistance test had a tendency to deteriorate, though it was at the practical level. Therefore, the moldability and the moisture/heat resistance of the molded article were poor.

As for Comparative example 2, since the equivalent ratio of the isocyanate group contained in the aromatic polyisocyanate curing agent to the hydroxyl group derived from the acrylic polyol (A) contained in the main agent was excessively small, the lamination strength after the moisture/heat resistance test had a tendency to deteriorate, though it was at the practical level. Therefore, the moldability and the moisture/heat resistance of the molded article were poor.

Further, as for Comparative example 3, since the number-average molecular weight of the acrylic polyol was excessively small, the lamination strength before/after the moisture/heat resistance test was poor. As for Comparative example 4, since the number-average molecular weight of the acrylic polyol was excessively large, the reaction between the hydroxyl group derived from the main agent and the isocyanate group derived from the curing agent was hindered. Therefore, the moldability had a tendency to deteriorate, though it was at the practical level, and the moisture/heat resistance of the molded article was poor.

Further, as for Comparative example 5, since the amount of the hydroxyl group derived from the acrylic polyol (A) contained in the main agent was excessively large, the density of the cross-linking between the acrylic polyol (A) and the aromatic polyisocyanate became excessively high, thus deteriorating the laminate strength. Further, the moldability and the moisture/heat resistance of the molded article had a tendency to deteriorate, though they were at the practical level.

Further, since Comparative example 6 used polyester polyol as the main agent, the hydrolysis was accelerated due to the moisture/heat resistance test. As a result, the moisture/heat resistance of the molded article was poor. Similarly, Comparative example 7 used polyester polyol as the main agent. Therefore, for the same reason, the moisture/heat resistance of the molded article was poor and the moldability was also poor. Further, in Comparative examples 6 and 7, the lamination strength after the moisture/heat resistance test had a tendency to deteriorate.

### INDUSTRIAL APPLICABILITY

A polyurethane adhesive according to the present invention can be applied to a wide range of adhesives for forming battery containers and battery packs. In particular, a polyurethane adhesive according to the present invention can be suitably used as an adhesive for forming a battery container or a battery pack for a secondary battery such as a lithium-ion battery, a lithium-ion polymer battery, a lead-acid battery, an alkaline battery, a silver-oxide/zinc battery, a metal-air battery, a polyvalent cationic battery, a condenser, and a capacitor. A polyurethane adhesive according to the present invention is used for bonding objects to be bonded made of the same material or different materials. For example, a polyurethane adhesive according to the present invention can be suitably used for bonding of a multi-layered laminate including a plastic-based material and a metal-based material. Needless to say, a polyurethane adhesive according to the present invention can also be used for bonding plastic-based materials with each other, or metal-based materials with each other. An adhesive according to the present invention can provide a laminate having excellent moldability, which is obtained by using the adhesive, have a high environmental tolerance, prevent or reduce the deterioration of the adhesive strength over time even under outdoor conditions, and maintain a high adhesive strength and an external shape over a long time. Therefore, an adhesive according to the present invention can also be used as an adhesive for a laminate that needs to have good moldability, such as PTP packaging and a steel sheet, and for a laminate for outdoor industrial use such as building structures such as protective wall materials, roof materials, solar panel materials, window materials, outdoor flooring materials, illumination protective materials, and automobile components.

This application is based upon and claims the benefit of priorities from Japanese patent applications No. 2013-34957, filed on Feb. 25, 2013 and No. 2013-255982, filed on Dec. 11, 2013, the disclosures of which are incorporated herein in their entirety by reference.

### REFERENCE SIGNS LIST

(11) OUTER LAYER SIDE RESIN FILM LAYER
(12) OUTER LAYER SIDE ADHESIVE LAYER
(13) METAL FOIL LAYER
(14) INNER LAYER SIDE ADHESIVE LAYER
(15) INNER SURFACE LAYER

1. A polyurethane adhesive for a battery packaging material comprising a main agent and a curing agent, wherein
a. the main agent contains an acrylic polyol (A) having a number-average molecular weight of 10,000 to 100,000 and a hydroxyl value of 1 to 100 mgKOH/g, and
b. an equivalent ratio [NCO]/[OH] of an isocyanate group derived from an aromatic polyisocyanate (B) contained in the curing agent to a hydroxyl group derived from the acrylic polyol (A) is 10 to 30.

2. The polyurethane adhesive for a battery packaging material according to claim 1, wherein a glass transition temperature (Tg) of the acrylic polyol (A) is −20 to 30° C.

3. The polyurethane adhesive for a battery packaging material according to claim 1, further comprising a silane coupling agent (C) and at least one type of an additive selected from a group consisting of a phosphoric acid and a phosphoric-acid-based compound (D).

4. A battery packaging material comprising, from an outer side thereof, an outer layer side resin film layer, an outer layer side adhesive layer, a metal foil layer, an inner layer side adhesive layer, and an inner surface layer as essential components, wherein the outer layer side adhesive layer is formed by a polyurethane adhesive for a battery packaging material according to claim 1.

5. The battery packaging material according to claim 4, wherein the outer layer side resin film layer is a polyamide film or/and a polyester film, and the inner surface layer is a polyolefin-based film.

6. A battery container molded from a battery packaging material according to claim 4, wherein
a. the battery packaging material comprises, from an outer side thereof, an outer layer side resin film layer, an outer layer side adhesive layer, a metal foil layer, an inner layer side adhesive layer, and an inner surface layer as essential components, and
b. the outer layer side resin film layer forms a convex surface and the inner surface layer forms a concave surface.

7. A battery formed by using a battery container according to claim 6.
